(19) United States
(12) Patent Application Publication
(10) Pub. No.: US 2014/0216627 A1
(43) Pub. Date: Aug. 7, 2014

(54) SURFACE COVER

(71) Applicant: Kerry Stumpe, Atlanta, GA (US)

(72) Inventor: Kerry Stumpe, Atlanta, GA (US)

(21) Appl. No.: 13/759,738

(22) Filed: Feb. 5, 2013

(51) Int. Cl. B32B 37/00

(52) U.S. Cl. CPC B32B 37/0053
USPC 156/60; 156/579

(57) ABSTRACT

A surface cover assembly includes a body, the body including at least one grasping point and surface covering material dispensably attached to the body. A method of applying a barrier over a use surface includes obtaining a surface cover assembly, the surface cover assembly including: a body including at least one grasping point and surface covering material dispensably attached to the body; grasping the grasping point of the body; and applying surface covering material to the use surface.

### TECHNICAL FIELD

This disclosure relates to hygiene. More particularly, this disclosure relates to surface covers.

### BACKGROUND

Use of restrooms and publicly available accommodations can expose individuals to pathogens, germs, diseases, and other potential dangers of unsanitary conditions. Particularly in public restrooms, the potential of contact with urine, fecal matter, and other bodily fluids may be extraordinarily high. Typical surface covers can be difficult to use, leaving a restroom user the choice between the cumbersome activity of attempting to utilize a surface cover or the unprotected use of the restroom facilities. In addition, baby changing tables are also at high risk to newborns and diaper-wearing infants, with no readily available surface cover.

### SUMMARY

A surface cover assembly includes a body, the body including at least one grasping point and surface covering material dispensably attached to the body. A method of applying a barrier over a use surface includes obtaining a surface cover assembly, the surface cover assembly including: a body including at least one grasping point and surface covering material dispensably attached to the body; grasping the grasping point of the body; and applying surface covering material to the use surface.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1A is an exploded perspective view of a surface cover assembly in accord with one embodiment of the current disclosure.

FIG. 1B is an exploded perspective view of a surface cover assembly in accord with one embodiment of the current disclosure.

FIG. 2A is a side view of a surface cover assembly in accord with one embodiment of the current disclosure.

FIG. 2B is a side view of a surface cover assembly in accord with one embodiment of the current disclosure.

FIG. 3 is a perspective view of a surface cover assembly in accord with one embodiment of the current disclosure.

FIG. 4A is a perspective view of a method of using the surface cover assembly of FIG. 1A.

FIG. 4B is a perspective view of a method of using the surface cover assembly of FIGS. 2A and 2B.

FIG. 4C is a perspective view of a method of using the surface cover assembly of FIG. 3. FIG. 5A is a detail view of a user's grasp of the surface covering assembly as shown in FIG. 4A.

FIG. 5B is a detail view of a user's grasp of the surface covering assembly as shown in FIG. 4B.

FIG. 5C is a detail view of a user's grasp of the surface covering assembly as shown in FIG. 4C.

### DETAILED DESCRIPTION

Typical toilet seat cover apparatus—such as that described in U.S. Pat. No. 1,608,988—allow for the application of a one-piece seat cover apparatus designed to at least roughly match the size and shape of a toilet. Such apparatus typically includes either a single-ply sheet of disposable paper or a non-disposable cover. Typically, a user aligns such seat cover apparatus with the toilet set—matching any aperture with the bowl and any protective area with the seat—and utilizes the toilet with the seat cover acting as a physical barrier between the seat and the user.

Multiple problems exist with such seat cover apparatus. In one example, many prior seat cover apparatus are large—in that they are typically one-piece and large enough to cover a toilet seat—and can be difficult and inconvenient for the average consumer to store and transport. Also, many seat cover apparatus are designed to be functional with toilets and, thus, are not practical for use on other surfaces. If such seat cover apparatus are used on any other use surface, they generally become inadequate and provide minimal protection against that particular use surface. Additionally, many seat cover apparatus are difficult to use with children. For example, when a parent seeks to use a seat cover as protection for young children, the seat cover may be difficult to apply to a seat and will often become disengaged from the seat prior to the parent being able to place the child on top of the cover, especially if the parent is trying to contain a child at the same time. Particularly for a parent attempting to protect a small child, it would be impractical or cumbersome to carry a large apparatus to be used consistently.

Disclosed is a surface cover and associated methods, systems, devices, and various apparatus. It would be understood by one of skill in the art that the disclosed surface cover is described in but a few exemplary embodiments among many. No particular terminology or description should be considered limiting on the disclosure or the scope of any claims issuing therefrom.

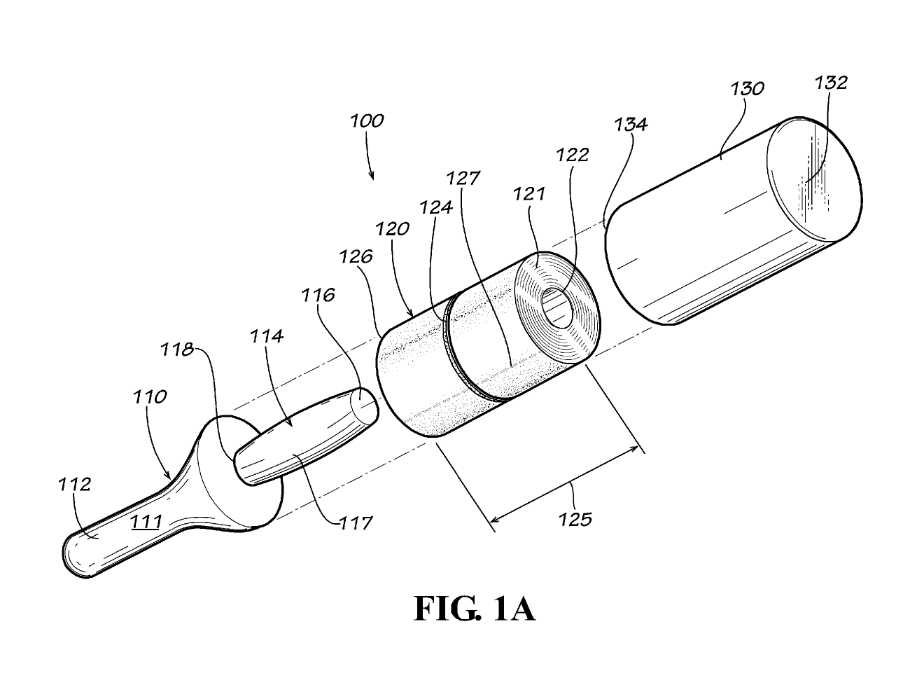

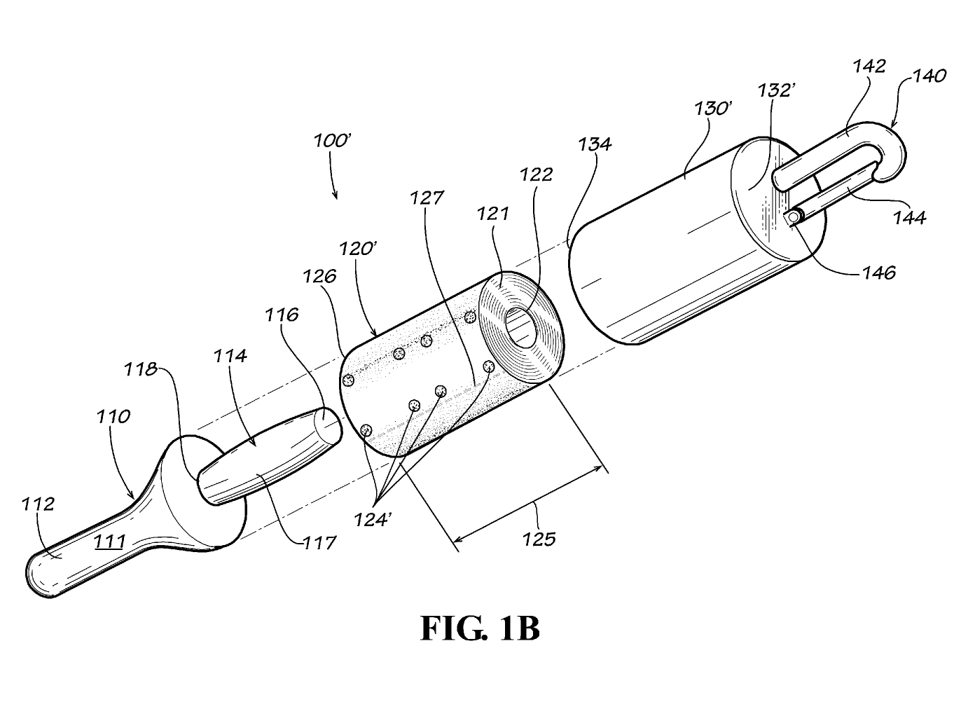

One embodiment of a surface cover assembly 100 is seen in FIG. 1A. Although one embodiment is shown and described, the embodiment of FIG. 1A should not be considered limiting on the disclosure, and multiple embodiments may be shown and described with reference to the figures herein.

The surface cover assembly 100 of the current embodiment includes a spindle 110 serving as a body of the surface cover assembly 100, surface covering 120, and a cover 130. The spindle 110 includes a handle 112 and a post 114. In various embodiments, a surface 111 of the handle 112 may be textured to promote grip. In the current embodiment, the post 114 interacts with the surface covering 120 to allow rotation of the surface covering 120 about the post 114. In the current embodiment, the post 114 is cambered such that a top end 116 and bottom end 118 of the post 114 are smaller in diameter than a portion of the post 114 nearer to a center 117 of the post 114. The camber of the post 114 provides some resistance to the surface covering 120, preventing undesired unraveling of the surface covering 120. However, in various embodiments, the post 114 may not be cambered. A hilt 119 is shown separating the handle 112 from the post 114. In the current embodiment, the hilt 119 rises gradually from the handle 112, although various arrangements of the hilt 119 may be available in various embodiments, and the hilt 119 may be absent in various embodiments. In the current embodiment, the spindle 110 is made of injection molded or blow-molded plastic, although various materials may be used, including various plastics, rubbers, metals, woods, foams, cardboards, and paper products, among others. Although shown as a one-piece construction in the current embodiment, the spindle 110 may be composed of various parts connected together—either removably or permanently. Such connections are known in the art and include use of adhesives, welding, screw-fit, and other mechanical connections, among others. Further, the spindle 110 may include any combination of colors, patterns, or imprinted images.

The surface covering 120 of the current embodiment includes surface covering material 121 arranged on a roll 122 such that the surface covering material 121 is dispensable and, thereby, is dispensably attached to the surface covering 120. The surface covering material 121 of the current embodiment is disposable paper. In various embodiments, the surface covering material 121 may be flushable, compostable, recyclable, or otherwise disposable. The surface covering material 121 of the current embodiment may be variants of toilet paper, tissue, wax paper, or the like, among others. The surface covering material 121 of the current embodiment is not porous, although in various embodiments, porous surface covering material 121 may be acceptable. In various embodiments, the surface covering material 121 may be antimicrobial or otherwise protect against exposure to pathogens. The surface covering material 121 may also include any combination of patterns, colors, or imprinted images.

The surface covering 120 of the current embodiment includes the roll 122, seen on the inside of the surface covering material 121. In various embodiments, the roll 122 may be omitted. In the current embodiment, a strip of adhesive 124 is seen proximate a center of the roll 122 to provide grip and act as a gripping surface of the surface covering material 121. In the current embodiment, the strip of adhesive 124 is not greater than one inch in width and is placed proximate the center of the surface covering material 121, although the strip of adhesive 124 may be larger, smaller, or include multiple strips in various embodiments, or may be located anywhere on the surface covering material 121. In various embodiments, the adhesive 124 may not be a strip but rather placed in various spots on the surface covering material 121. The adhesive 124 may vary depending on the application. However, in the current embodiment, the adhesive 124 is biodegradable—and, therefore, flushable. The adhesive 124 of the current embodiment is shown as a small strip for easy application and removal of the surface covering 120 and to provide a light grip between the surface covering 120 and any surface for which the surface covering 120 may be used, including a seat. In various embodiments, various adhesives may be used, including glues (both biodegradable and inorganic), tapes, rubbers, and mechanical joining surfaces such as Velcro and suction cups, among others suction devices. The adhesive 124 aids the surface covering material 121 in gripping a surface for application; however, the adhesive 124 also aids in keeping the surface covering material 121—currently disclosed as a roll of material—from unraveling. In various embodiments, the surface covering material 121 itself may include a friction-inducing surface. In various embodiments, it may prove unnecessary to generate friction between the surface covering material 121 and any application surface; in such embodiments, adhesives or gripping arrangements may be omitted.

The surface covering material 121 of the current embodiment extends from a first end 126 that rests against or near the hilt 119 to a second end 128, as shown. The width 125 from the first end 126 to the second end 128 is somewhat larger than a typical width of one side of a toilet seat. In one embodiment, the width 125 from the first end 126 to the second end 128 is about the same as a roll of toilet paper, although the width 125 may be smaller or larger in various embodiments. In the current embodiment, the width 125 is four and three-fourths inches (4.75 inches). In various embodiments, the surface covering material 121 may be smaller such that the overall surface cover assembly 100 may be small enough to be easily portable in a handbag, shoulder bag, pocket, or other method.

The surface covering material 121 of the current embodiment include perforations 127 at various lengths to aid in tearing the surface covering material 121. In the current embodiment, the lengths between perforations 127 are about the length of a typical toilet seat from front to back, although other lengths may be present in various embodiments. In various embodiments, the surface covering material 121 will be sufficiently tearable that perforations 127 will not be necessary.

The cover 130 is a hollow cylinder and may be open top or closed top. In the current embodiment, the cover 130 includes a closed top 132 that may touch or approach the second end 128 when applied over the surface covering 120. The cover 130 protects the surface covering 120 from debris and other contaminants that may be introduced to the surface cover 120 that may tear the surface covering material 121 or dirty the adhesive 124. In the current embodiment, the hilt 119 includes a ledge to interact with a first end 134 of the cover 130 to provide an enclosure. In the current embodiment, the interaction is a snap-fit, although various embodiments may include various interactions, including screw-on (threaded) interaction, mechanical locking, and various adhesives, among other mechanical interactions.

In the current embodiment, all apparatus are circular in cross-section. However, such a configuration is not necessary and should not be considered limiting on the disclosure. In various embodiments, it may be advantageous to include at least one flat side to aid in laying the surface cover assembly 100 on its side. In various embodiments, hooks, clips, latches, holes, lanyards, or other mechanical arrangements may be included and/or attached to the surface cover assembly 100 to aid with temporary or permanent storage, such as allowing the surface cover assembly 100 to be hung on a hook or more easily carried from place to place.

Another embodiment of a surface cover assembly 100′ is shown in FIG. 1B. The surface cover assembly 100′ includes the spindle 110 and an alternative embodiment of the surface covering 120′ and a cover 130′. The surface covering 120′ is similar to the surface covering 120 except that the strip of adhesive 124 has been replaced with a plurality of adhesive dots 124′. The strip of adhesive 124 and the plurality of adhesive dots 124′ are two of many different patterns of adhesive that may be applied to the material 121, and the pattern of adhesive should not be considered limiting.

FIG. 1B also shows an alternative embodiment of the cover 130′. The cover 130′ is similar to the cover 130 except that the cover 130′ includes a clip 140 formed on a closed top 132′. The clip 140 includes a clip hook 142 and a clip gate 144, the clip gate 144 being connected to the closed top 132′ by a hinged clip connection 146. In the current embodiment, the hinged clip connection 146 biases the clip gate 144 against the clip hook 142. The clip hook 142 and 146 are formed integrally on the closed top 132′, but may be connected in any manner, such as gluing, welding, or fastening. Further, the clip gate 144 may be coupled directly to the closed top 132′ through gluing, welding, fastening, or being formed integrally there, or any other manner, and may be bendable or rigid. Moreover, the clip 140 may be attached anywhere on the cover 130 or, in various embodiments, may be attached to the spindle 110, such as on the end of the handle 112. The clip 140 allows the surface cover assembly 100′ to be easily attached to a bag, stroller, purse, belt, or any other object to allow for a portability option for the surface cover assembly 100′. The clip 140 may be the clip hook 142 by itself in various embodiments as well, to allow the surface cover assembly 100′ to be easily hung on an object such as a bag or stroller. Cover 130′ may also be used with surface covering 120 or any other surface covering having a different pattern of adhesive.

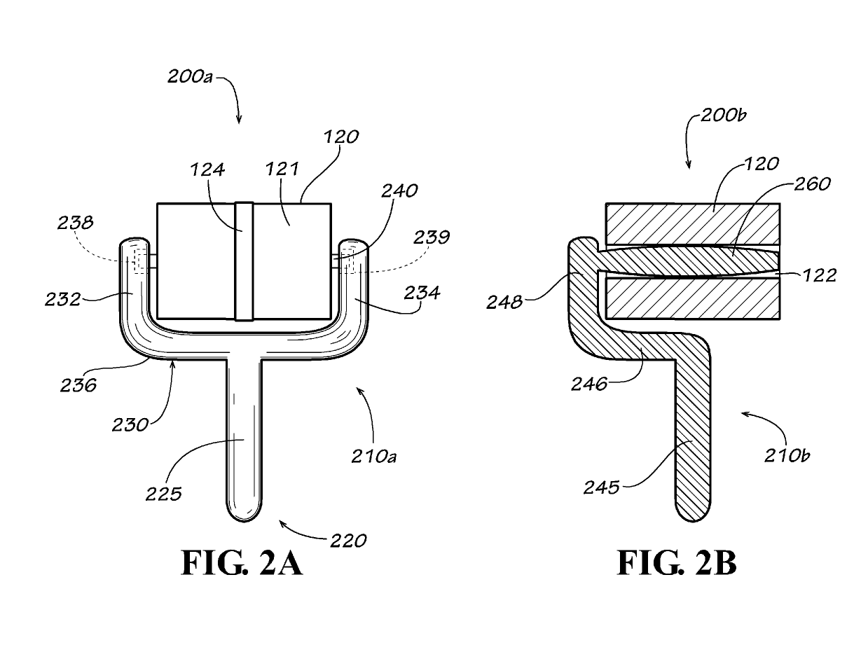

Another embodiment of a surface cover assembly 200a is shown in FIG. 2A. The surface cover assembly 200a includes the surface covering 120 and a spindle 210a serving as a body of the surface cover assembly 200a. The spindle 210a includes a fixed holder 220 that includes a handle portion 225 and a wishbone portion 230. Although shown as a one-piece construction in the current embodiment, the fixed holder 220 may be composed of various parts connected together—either removably or permanently. Such connections are known in the art and include use of adhesives, welding, screw-fit, and other mechanical connections, among others.

In the current embodiment, the wishbone portion 230 includes a first arm 232 and a second arm 234 upstanding and projecting from a base portion 236 parellel to each other and perpendicular to the base portion 236. The first arm 232 includes a notch 238, and the second arm 236 includes a notch 239. The spindle 210a includes a post 240. In the current embodiment, the post 240 is a separate part from the fixed holder 220. In various embodiments, the post 240 may be integral with the fixed holder 220 and may include various subparts to allow attachment and removal of the surface covering 120. The surface covering 120 of the current embodiment is rotatably connected to the post 240 as the post 240 is fed through the roll 122 (see FIG. 1A). The post 240 is then connected to the wishbone portion 230 by placing each end of the post 240 into one notch 238, 239. In practice, the post 240 may be collapsible to allow it to fit between the first arm 232 and the second arm 236. The post 240 may also include a spring or other biasing element to allow it to seat inside the notches 238, 239 after passing the first arm 232 and the second arm 234. In various embodiments, the notches 238, 239 and the post 240 may include snap-fit arrangements such that the post 240 need not be collapsible to seat each end in one notch 238, 239. In various embodiments, the first arm 232 and the second arm 234 may include a separate cover that removably attaches over each notch 238, 239 to capture the ends of the post 240. Various other configurations of mechanical connection are known in the art and would be obvious to one of ordinary skill in the art.

A similar embodiment is shown with reference to FIG. 2B. In the current embodiment, a surface cover assembly 200b is shown including the surface covering 120 and a spindle 210b serving as a body of the surface cover assembly 200b. The spindle 210b of the current embodiment is a unitary structure and includes a handle portion 245, a base portion 246, and a single upstanding arm 248 extending from the base portion 246. In the current embodiment, a post 260 extends orthogonally from the arm 248 and includes a camber, similar to the post 114 of the embodiment of FIG. 1A. Although shown as a one-piece construction in the current embodiment of FIG. 2B, the spindle 210b may be composed of various parts connected together—either removably or permanently. Such connections are known in the art and include use of adhesives, welding, screw-fit, and other mechanical connections, among others.

Both surface cover assembly 200a and surface cover assembly 200b may include surface covering 120′ in various embodiments, or any other pattern of adhesives on material 121. Surface cover assembly 200a and surface cover assembly 200b may also include a clip on spindle 210a or spindle 210b, for example at the end of handle portion 225 or handle portion 245, for portability purposes. In various embodiments, hooks, latches, clips, holes, lanyards, or other mechanical arrangements may be included and/or attached to the surface cover assembly 200a or surface cover assembly 200b to aid with temporary or permanent storage, such as allowing the surface cover assembly 200a or surface cover assembly 200b to be hung on a hook or more easily carried from place to place. Surface cover assembly 200a and surface cover assembly 200b may also include a cover to go over surface covering 120, which may attach to one or both of first arm 232 and second arm 234 of surface cover assembly 200a or to one or both of post 260 or upstanding arm 248 of surface cover assembly 200b in various embodiments.

Another embodiment is shown with reference to FIG. 3. In the current embodiment, a surface cover assembly 300 includes a casing 310—serving as a body of the surface cover assembly 300—and surface covering 320. The surface covering 320 of the current embodiment includes a surface covering material 330 and a backing 340. The surface covering material 330 is applied to the backing 340 with an adhesive, similar to adhesives already discussed with reference to the surface covering 120 and 120′ such that the surface covering material 330 is dispensable and, thereby, is dispensably attached to the surface covering 320. The surface covering 320 includes a material roll 322 and a discard roll 324. The material roll 322 includes both the surface covering material 330 and the backing 340. The discard roll 324 includes only backing 340 to be discarded. The casing 310 of the current embodiment includes posts (not shown) on which each of the material roll 322 and the discard roll 324 are aligned and around which such rolls 322,324 rotate. The arrangement allows the unwinding of the material roll 322 to allow a user to place surface covering material 330 on a surface while simultaneously rolling the discard roll 324 with material backing 340 to be discarded. In practice, the material roll 322 and the discard roll 324 may be on spools to aid in winding/unwinding. In practice, the material roll 322 and the discard roll 324 may be coupled—for example, by mechanical gears—to force the discard roll 324 to rotate, thereby promoting the winding of the discard roll 324 with backing 340. Additionally, a post (not shown) keeps the surface covering material 330 and backing 340 extended at an application tip 355 of the casing 310 such that the surface covering material 330 and backing 340 does not fall back into the casing 310. The problem, however, may be addressed by moving the discard roll 324 closer to the application tip 355.

The surface cover assembly 300 of the current embodiment is not refillable, as the casing 310 is permanent. In the current embodiment, the casing 310 is clear plastic, allowing viewing of the material roll 322 and discard roll 324. In various embodiments, the casing 310 may be made of a variety of materials as discussed previously in this disclosure. Further, the casing 310 may include any combination of colors, patterns, or imprinted images. In various embodiments, the casing 310 may be made of multiple removable parts such that the material roll 322 and the discard roll 324 are separable from the casing 310 and replaceable, making the surface cover assembly 300 refillable. The surface cover assembly 300 of the current embodiment prevents the introduction of contaminants to the surface covering material 330 for at least two reasons. First, the surface covering material 330 is enclosed within the casing 310; second, the surface covering material 330 is rolled with the backing 340, so contaminants are not able to stick to the surface covering material 330 easily. In various embodiments, the surface covering material 330 may be arranged on a movable spindle or tray such that the surface covering material 330 can be exposed from or nested within the casing 310.

Surface cover assembly 300 may include a clip on casing 310 for portability purposes. In various embodiments, hooks, latches, clips, holes, lanyards, or other mechanical arrangements may be included and/or attached to the surface cover assembly 300 to aid with temporary or permanent storage, such as allowing the surface cover assembly 300 to be hung on a hook or more easily carried from place to place.

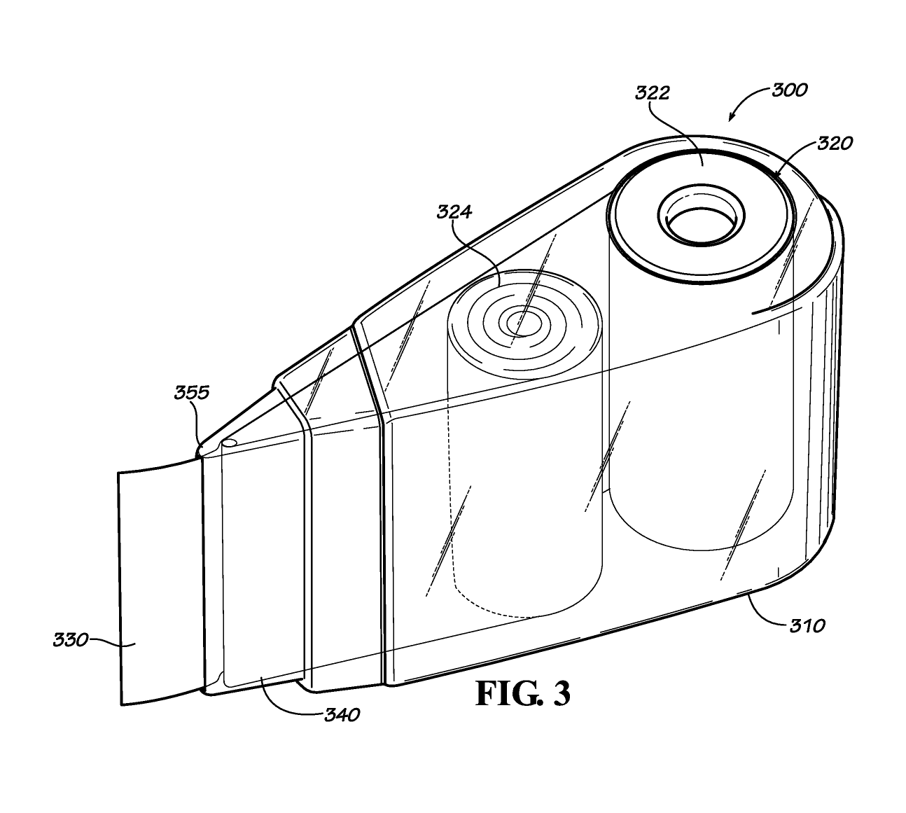

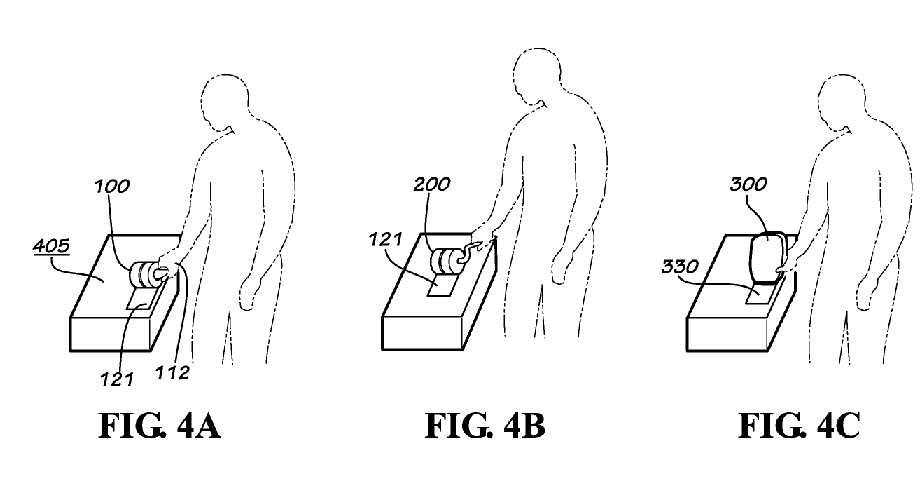

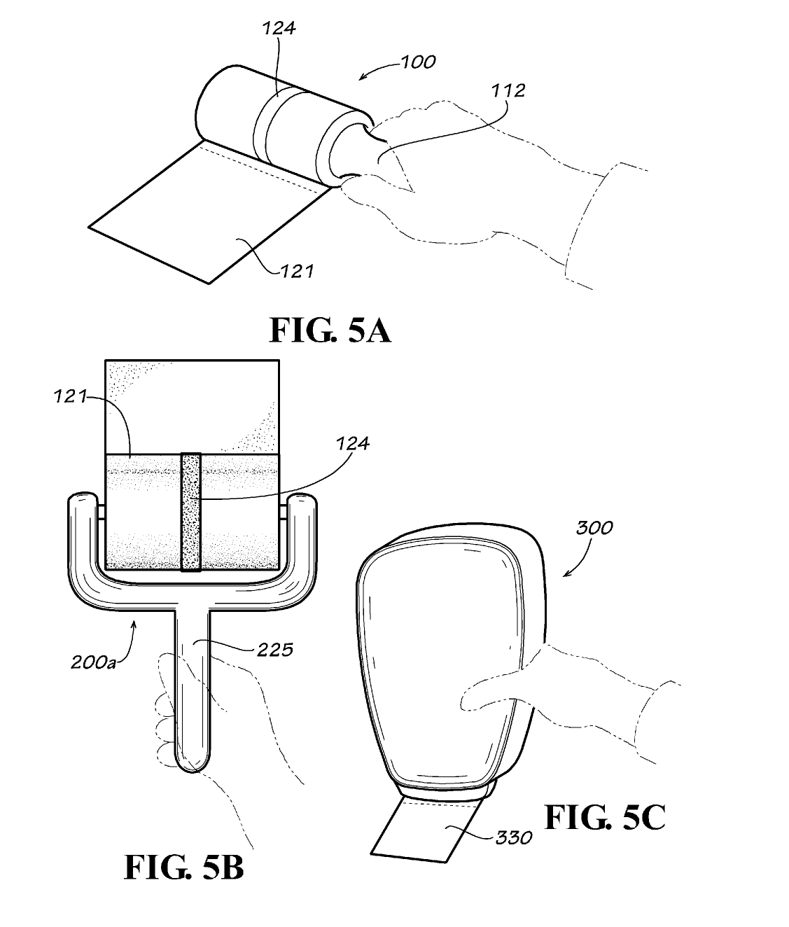

Methods of use of the various embodiments as disclosed are shown with reference to FIGS. 4A-4C. As can be seen with reference to FIG. 4A, the surface cover assembly 100 can be used to apply surface covering material 121 to a surface 405. A user grasping the handle 112 applies sufficient pressure to the handle 112 to seat the adhesive 124 (see FIG. 1A) along the surface 405, temporarily securing the surface covering material 121 to the surface 405. In such a way, the user may provide a temporary covering over surface 405 to act as a barrier between the surface 405 and any person who may sit on the surface covering material 121, come into contact with the surface covering material 121, or place any other object on the surface covering material 121. Uses of surface cover assembly 200a,200b and surface cover assembly 300 are also shown with reference to FIGS. 4B and 4C. FIGS. 5A, 5B, and 5C each show detail of the user grasping the surface cover assembly 100, 200a, and 300, respectively, as the user would grasp and apply surface covering material 121 and 330. As shown in FIGS. 5A and 5B, a grasping point for each of surface cover assembly 100, 200a, and 200b is at handle 112, handle portion 225, and handle portion 245 (not shown), respectively. With respect to surface cover assembly 300, a grasping point is along the casing 310. Multiple grasping points may be defined along each body, and the current disclosure should not be considered limiting on the possible structures that may be implemented.

Although surface covering material 121 and 330 is disclosed on a roll in the current embodiment, multiple embodiments are considered within the scope of this disclosure. In various embodiments, the surface covering material may be stacked, layered, or dispensed in methods other than by a roll. The surface cover assemblies 100, 200a, 200b, 300 are primarily described herein with reference to toilet seats, although the surface cover assemblies 100, 200a, 200b, 300 may be used on various use surfaces, including baby changing stations, chairs, benches, tables, grocery cart handles, restaurants, amusement rides, and any other location in which a barrier may be desired.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

1. A surface cover assembly comprising:
a body, the body including at least one grasping point; and
surface covering material dispensably attached to the body, the surface covering material including biodegradable paper, the surface covering material arranged on a roll such that the surface covering material is rolled around itself, the surface covering material including a leading edge, the surface covering material dispensable by tension on the leading edge to unroll the surface covering material off the body onto a surface.

2. The surface cover assembly of claim 1, wherein the surface covering material includes a gripping surface.

3. The surface cover assembly of claim 2, wherein the gripping surface is a plurality of adhesive dots.

4. The surface cover assembly of claim 2, wherein the gripping surface is a strip of adhesive.

5. The surface cover assembly of claim 4, wherein the surface covering material is disposable.

6. The surface cover assembly of claim 5, wherein the surface covering material is flushable.

7. The surface cover assembly of claim 4, wherein a width of the strip of adhesive is smaller than a width of the surface covering material.

8. The surface cover assembly of claim 7, wherein the strip of adhesive is no more than one inch in width.

9. The surface cover assembly of claim 8, wherein the surface covering material is not smaller than 4.75 inches in width.

10. The surface cover assembly of claim 8, wherein the adhesive is biodegradable.

11. The surface cover assembly of claim 1, wherein the surface covering material is on a roll.

12. The surface cover assembly of claim 11, wherein the roll is on a post.

13. The surface cover assembly of claim 11, wherein the surface covering material includes perforations.

14. The surface cover assembly of claim 1, wherein the body is a spindle.

15. The surface cover assembly of claim 14, wherein the spindle includes a handle.

16. The surface cover assembly of claim 1, wherein the body is a casing.

17. The surface cover assembly of claim 16, wherein the casing includes an application tip.

18. The surface cover assembly of claim 1, further comprising a clip.

19. The surface cover assembly of claim 1, further comprising a cover positionable over the surface covering material.

20. A method of applying a barrier over a use surface, the method comprising:
obtaining a surface cover assembly, the surface cover assembly including:
a body including at least one grasping point; and
surface covering material dispensably attached to the body, the surface covering material including biodegradable paper, the surface covering material arranged on a roll such that the surface covering material is rolled around itself;
grasping the grasping point of the body; and
applying surface covering material to the use surface by rolling the surface covering material over a surface.

21. The method of claim 20, wherein the surface cover assembly includes at least one adhesive gripping surface.

22. The method of claim 21, wherein the step of applying the surface covering material to the surface includes seating the adhesive gripping surface on the use surface.

23. The method of claim 20, further comprising disposing of the surface covering material.

24. The method of claim 20, wherein the use surface is a toilet seat.

25. The method of claim 20, wherein the biodegradable paper is not porous.

26. The surface cover assembly of claim 1, wherein the biodegradable paper is not porous.
